(19) United States
(12) Patent Application Publication
(10) Pub. No.: US 2007/0146685 A1
(43) Pub. Date: Jun. 28, 2007

(54) DYNAMIC WAFER STRESS MANAGEMENT SYSTEM

(76) Inventors: Woo Sik Yoo, Palo Alto, CA (US); Kitaek Kang, Dublin, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/625,778

(22) Filed: Jan. 22, 2007

Related U.S. Application Data
(63) Continuation-in-part of application No. 11/291,246, filed on Nov. 30, 2005.

(51) Int. Cl. G01B 11/16; G01B 11/24

(52) U.S. Cl. 356/32; 356/601

(57) ABSTRACT

Systems and techniques for characterizing samples using optical techniques are described. Light may be incident on a sample in the form of a pre-defined pattern which impinges on a wafer surface, and a reflection of the pattern is detected at a detector. Information indicative of changes in the pattern after reflection may be used to determine one or more sample characteristics and/or one or more pattern characteristics, such as stress, warpage, and curvature. The light may be coherent light of a single wavelength, or may be light of multiple wavelengths, and the pattern may be generated by transmission of the light through a diffraction grating, or hologram. The light source may be incoherent or multi-wavelength, and the pattern may be generated by imaging a pattern disposed on a mask on the sample and re-imaging the pattern at the detector.

### CROSS REFERENCE TO RELATED APPLICATIONS

This application is a Continuation-In-Part application of U.S. patent application Ser. No. 11/291,246, entitled “Optical Sample Characterization System”, filed on Nov. 30, 2005.

### BACKGROUND

1. Field of Invention

This invention generally relates to wafer processing, and in particularly to measuring wafer stress and patterns.

2. Related Art

Optical techniques may be used to obtain information about materials. For example, optical techniques may be used to characterize substrates such as semiconductor wafers. Characterization can include measuring stress on the wafer and patterns on the wafer to determine flatness, distortion, warpage, etc.

As the device density on wafers increases, it is more important to quickly obtain accurate information about the unpatterned (blanket) and patterned substrates. However, existing techniques may be time-consuming and cumbersome, and may not sample the wafer adequately. Additionally, some existing techniques are destructive; that is, they require that the wafer be damaged in order to analyze the patterned device elements. Therefore, characterization of actual product wafers may not be performed.

Techniques that may be used to characterize patterned wafers include the inspection of patterns using a high magnification optical microscope, scanning electron microscope (SEM), or other imaging technique. However, these techniques may not provide a complete picture of the wafer patterns. Since a patterned wafer may contain millions or tens of millions of device elements (e.g., transistors), only a small percentage of the device elements may be characterized.

Another technique that may be used to characterize wafers is ellipsometry. Ellipsometry is an optical technique that measures the change in polarization as light is reflected off a surface. Although ellipsometry is an important tool for obtaining information about some sample characteristics (e.g., for measuring layer thickness and refractive index), it does not provide information about some other sample characteristics, such as stress and pattern integrity.

### SUMMARY

Systems and techniques are disclosed for characterizing samples (such as patterned and unpatterned substrates) to obtain sample information. The techniques may be used to quickly obtain information about sample characteristics such as sample curvature, warpage, stress, and contamination. For patterned samples, the techniques may provide pattern information as well as sample information.

In general, in one aspect, a sample characterization system includes a sample holder configured to position a sample to be characterized and a detection system positioned and configured to receive diffracted light from the sample. The diffracted light may comprise a first diffraction pattern corresponding to diffracted light of a first wavelength and a second diffraction pattern corresponding to diffracted light of a second different wavelength. The sample holder may be configured to move the sample relative to a probe beam.

The detection system may be further configured to generate a signal indicative of a first intensity of diffracted light corresponding to a first region of the sample surface at a first position of the detection system. The detection system may be further configured to generate a signal indicative of a second intensity of diffracted light corresponding to the first region of the sample surface at a second position of the detection system different than the first position.

The system may further include a processor configured to receive a signal indicative of the first intensity and the second intensity. The processor may be further configured to determine one or more sample surface characteristics of the first region of the sample surface using the signal indicative of the first intensity and the second intensity. The sample surface characteristics may include at least one of substrate stress, substrate warpage, substrate curvature, and substrate contamination.

The substrate may be a patterned substrate, and the processor may further be configured to determine one or more pattern characteristics of the first region of the sample surface. For example, the pattern characteristics may include pattern periodicity, pattern accuracy, pattern repeatability, pattern abruptness, pattern damage, pattern distortion, and pattern overlay.

The system may further include a coherent light source positioned to transmit light to be diffracted by the sample. The coherent light source may comprise a single wavelength source or a multiple wavelength source.

The detection system may comprise a screen positioned a distance from the sample holder, and may further comprise a camera positioned to receive light from the screen and to generate the signal indicative of the first intensity and the signal indicative of the second intensity. The camera may comprise at least one of a charge coupled device (CCD) camera, a complementary metal oxide semiconductor (CMOS) camera, and a photodiode detector array.

In general, in another aspect, an article comprises a machine-readable medium embodying information indicative of instructions that when performed by one or more machines result in operations comprising receiving information indicative of a first intensity of a diffraction pattern at a first position of a detection system, the diffraction pattern including light diffracted from a first region of a sample. The operations may further comprise receiving information indicative of a second intensity of the diffraction pattern at a second different position of the detection system. The operations may further comprise determining one or more sample surface characteristics of the first region of the sample using the data indicative of the first intensity and the data indicative of the second intensity. The operations may further comprise receiving information indicative of a different intensity of a different diffraction pattern at the first position of the detection system, wherein the different diffraction pattern includes light diffracted from a second different region of a sample.

In general, in another aspect, a method of sample characterization may comprise: receiving coherent light at a first region of a sample and detecting diffracted light from the first region of the sample at a detection system. The method may further comprise generating a signal indicative of a first intensity of the diffracted light corresponding to the first region at a first position of the detection system and generating a signal indicative of a second intensity of the diffracted light corresponding to the first region at a second different position of the detection system. The method may further comprise determining one or more sample surface characteristics based on the signal indicative of the first intensity and the signal indicative of the second intensity.

In general, in another aspect, a sample characterization system includes a sample holder configured to position a sample to be characterized and a detection system positioned and configured to receive light reflected from the sample. The light may comprise a pre-defined pattern, projected toward the sample, produced by transmission of a light beam through a pattern generating mask. The sample holder may be configured to move the sample relative to a probe beam. The mask may comprise a diffraction grating, hologram, patterned transmission plate, or the like, to provide dispersal of the beam into a pre-defined pattern. The pattern is projected onto the wafer, as indicated above. The characterization system, comprising at least a detector, processor, controller, screen, camera and a machine-readable medium embodying information indicative of instructions that when performed result in operations is similar to that described above for other embodiments of a characterization system.

In another aspect, the system may further include a light source that may be coherent, preferably where the transmission mask relies on diffraction for pattern formation. The coherent light source may comprise a single wavelength source or a multiple wavelength source.

In another aspect, the system may further include a light source that may be incoherent and/or broad spectrum, preferably where, the patterning mask is a pattern that is imaged on the sample surface with suitable optical elements. In this aspect, the image at the sample is re-imaged at the screen by additional suitable optics. In this aspect, the optical elements may preferably be achromatic.

In another aspect, the system may further include a cassette sample delivery system for supplying samples, such as semiconductor wafers, to a sample handler, such as, for example, a robotic arm, which may place a sample on a stage for aligning and positioning the sample for characterization, and a cassette sample receiving system for receiving characterized samples.

In general, in another aspect, a method of sample characterization may comprise receiving a patterned beam of light illuminating the entire surface of the sample and detecting the image of the reflected pattern at a detection system. The method may further comprise generating a signal indicative of the pattern of the detected image. The method may further comprise determining stress and warp of a sample based on the signal indicative of the detected image.

In general, in another aspect, a method of sample characterization may comprise receiving a patterned beam of light illuminating a portion the surface of the sample and detecting the image of the pattern at a detection system. The sample may be translated, or the patterned beam may be directed to illuminate successive portions of the surface of the sample. The detection system may be correspondingly moved in order to receive the reflected image of the pattern. The method may further comprise determining stress and warp of a portion of the sample based on the signal indicative of the detected image.

These and other features and advantages of the present invention will be more readily apparent from the detailed description of the exemplary implementations set forth below taken in conjunction with the accompanying drawings.

### BRIEF DESCRIPTION OF THE DRAWINGS

FIG. 1 is a schematic diagram of a sample characterization system, according to some embodiments;

FIG. 2A is a warpage contour map that may be obtained using a system such as the system of FIG. 1;

FIG. 2B is a curvature vector analysis map that may be obtained using a system such as the system of FIG. 1;

FIG. 3 is a schematic diagram of a sample characterization system, according to some embodiments;

FIG. 4 is a diffraction pattern that may be obtained using a system such as the system of FIG. 3; and

FIG. 5 is a diffraction pattern of a patterned sample obtained using a laser light source.

FIG. 6 is a schematic diagram of a sample characterization system, according to some embodiments;

FIG. 7 is a schematic diagram of a sample characterization system, according to some embodiments;

FIG. 8 illustrates various types of beam patterns that may be used in a sample characterization system, according to some embodiments.

FIG. 9 illustrates various types of distorted beam patterns that may be detected in a sample characterization system, according to some embodiments.

FIG. 10 is a schematic illustration of a workstation that includes a sample characterization system and a sample handling system, according to some embodiments.

Like reference symbols in the various drawings indicate like elements.

### DETAILED DESCRIPTION

Systems and techniques provided herein may allow for efficient and accurate sample characterization. Both patterned and unpatterned wafers may be quickly characterized by analyzing diffraction patterns generated when coherent light is diffracted by a sample. Further, both patterned and unpatterned wafers may be quickly characterized by analyzing a reflected pattern projected on and reflected from wafers when the pattern is generated from a light source. Further, the techniques are non-destructive, so that actual product wafers may be characterized (if desired).

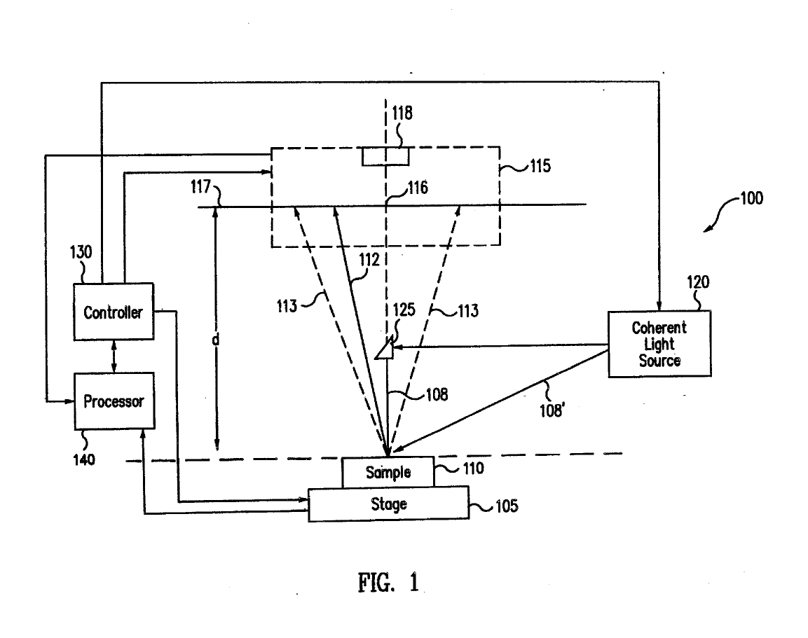

FIG. 1 shows an embodiment of a system 100 configured to characterize a sample 110, such as a patterned or unpatterned semiconductor wafer. Light is generated by a coherent light source 120, and a probe beam 108 is directed to sample 110 using (for example) a prism 125.

Sample 110 may be mounted on a stage 105 so that relative movement between sample 110 and probe beam 108 may be provided. Stage 105 may be a translation and rotation stage (e.g., an X, Y, Θ stage), that may additionally comprise a goniometer (e.g., φ rotation about an axis in the X-Y plane). Probe beam 108, which may be about 0.1 μm (micrometer) to 10 mm in its major dimension (e.g., its diameter for a substantially circular beam), may be scanned across sample 110 to obtain data at a plurality of positions. For example, probe beam 108 may be raster scanned across sample 110 to obtain data for a “map” of sample characteristics. Note that one or more optical elements may be used to increase or decrease the size of probe beam 108 at sample 110. Smaller probe beams 108 may be used to obtain more detailed information about sample 110, while larger probe beams 108 may be used to characterize a wafer more quickly. This provides significant flexibility for different characterization applications.

In order to characterize sample 110, light is diffracted from sample 110 and a diffraction pattern is detected at a detection system 115 having a portion positioned a distance d from the surface. For example, detection system 115 may include a screen 117 positioned a distance d from sample 110, and a camera 118 (such as a CCD camera) positioned to receive light from screen 117 and to generate one or more signals indicative of the received light. The screen may detect reflected light 112 (the zeroth order diffraction maximum), as well as higher order diffracted beams 113 (e.g., light corresponding to first order diffraction maxima).

The example of FIG. 1 shows an embodiment in which light is incident on sample 110 normal to the ideal position of the surface of sample 110 (i.e., normal to a plane corresponding to the ideal position of the surface). If the surface of sample 110 is not flat in the region sampled by the incident light, the reflected beam 112 will intersect screen 117 at a position 116′ offset from an ideal position 116. The offset may be referred to as the warpage vector.

Light may also be spectrally incident on the surface of sample 110 (i.e., at an angle other than perpendicular to the expected position of the surface of sample 110, as indicated with probe beam 108′). For such embodiments, detection system 115 may have a portion positioned to receive diffracted light from sample 110. Sample surface characteristics and/or pattern characteristics may be calculated using techniques that account for the particular angle of incidence used.

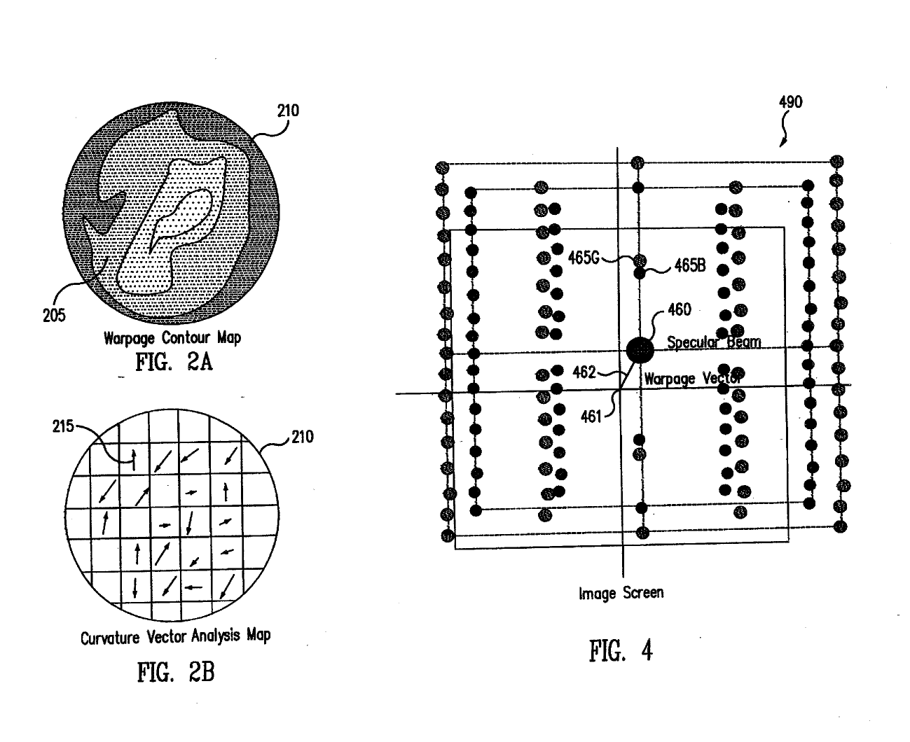

When sample 110 comprises an unpatterned wafer, the resulting diffraction pattern may be indicative of sample surface characteristics such as wafer warpage, curvature, global and local stress, and may indicate the presence of contaminants (e.g., particles). The detected signal may be used to characterize the unpatterned wafer in a number of ways. For example, FIG. 2A shows a warpage contour map 205 of a sample 210 (such as an unpatterned wafer). FIG. 2B shows a curvature vector analysis map 215 of sample 210.

When sample 110 is a patterned wafer, the resulting diffraction pattern is indicative not only of wafer warpage and stress, but also of pattern characteristics. System 100 may provide large area pattern integrity characterization by reverse Fourier transform of the diffracted image to obtain pattern information. For example, information indicative of periodicity, pattern accuracy, pattern repeatability, pattern abruptness, pattern damage, pattern distortion, and pattern overlay may be obtained.

System 100 may further include one or more controllers such as a controller 130, and one or more processors such as a processor 140. Controller 130 may control stage 105, light source 120, and/or detection system 115. For example, controller 130 may control stage 105 to position sample 110 so that probe beam 108 is sampling a first region at a first time, and may control detection system 115 to obtain data at the first time. At a second later time, controller 130 may control stage 105 to position sample 110 so that probe beam 108 is sampling a second different region at a second later time, and may control detection system 115 to obtain data at the second later time. Controller 130 may control light source 120 to select one or more particular wavelengths, or to control other parameters.

Processor 140 may receive information indicative of a position on sample 110 being characterized at a particular time, and may also receive information indicative of an intensity of a diffraction pattern at different positions of detection system 115 at the particular time. Processor 140 may determine sample characteristics (such as wafer characteristics and/or pattern characteristics) using the received information.

A system such as system 100 of FIG. 1 may provide fast, accurate, and flexible characterization of a sample. For example, the beam size may be tailored to sample a desired area at a particular time. Additionally, the distance d between the sample and the detection system may be increased or decreased to increase or decrease the effective magnification, as well as to improve resolution.

Additional benefits may be obtained by characterizing the sample using multiple wavelengths of coherent light. For diffractive elements characterized by a periodic distance d being illuminated by light of wavelength □ at an incident angle □ᵢ and diffracted at an angle □ₙ, the diffraction condition is n □=d (sin □ₙ−sin □ᵢ) (where n is the order of the nth diffracted beam). Because the diffraction condition is dependent both on pattern size and wavelength, different wavelengths of light will interact differently with different patterns.

Additional benefits may be obtained by characterizing the sample using different diffraction orders generated, at a single wavelength, by a pattern characterized by a periodic distance d at a first region of the sample. Specifically, diffracted beams of different order values of n will be generated at different angles, according to the diffraction condition described above. Different beams will appear at different locations on screen 117, and therefore, at a different position, as received by detection system 115. Detection system 115 may not be positioned to receive both orders of beams diffracted from the same region of sample 110. However, detection system 115 may be placed at a first position to receive a first diffracted beam of one order from a first region of the sample, and simultaneously receive a second diffracted beam of another order from a second region of the sample. Alternatively, detection system 115 can be placed at a first position to receive a first diffracted beam of one order from a first region of the sample and then placed at a second position to receive a second diffracted of another order from the first region of the sample.

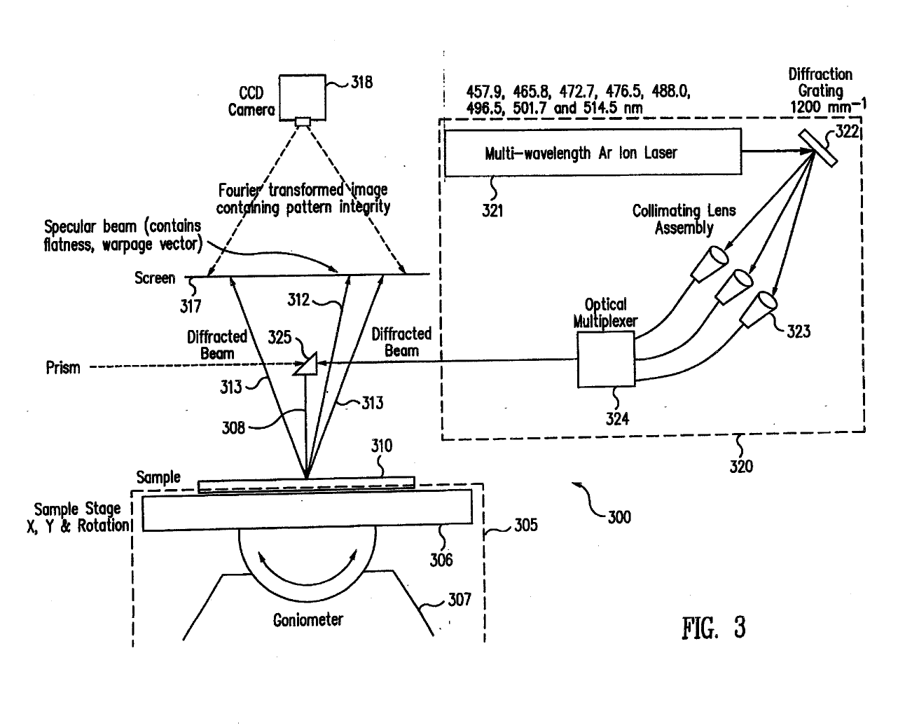

FIG. 3 shows a system 300 configured to generate a probe beam 308 including a plurality of wavelengths that may be used to characterize a sample 310 such as a semiconductor wafer. A coherent light source 320 includes one or more lasers such as multi-wavelength argon ion laser 321, to generate coherent light of at least two different wavelengths. For example, an argon ion laser can generate light having wavelengths of 457.9, 465.8, 472.7, 476.5, 488.0, 496.5, 501.7, and 514.5 nm. Although FIG. 3 shows a single laser generating multiple wavelengths, multiple lasers may be used.

The light may be dispersed according to wavelength using a dispersive element such as a diffraction grating 322 (e.g., a 1200 mm⁻¹ grating). Each of the wavelengths of the dispersed light may be collimated using a collimating lens assembly 232, and then multiplexed using an optical multiplexer 324. The resulting light may be directed to sample 310 using one or more elements such as a prism 325. As noted above, light may be directed to sample 310 at normal incidence, or may be directed to sample 310 spectrally.

In the example of FIG. 3, stage 305 comprises an X-Y translation stage 306 and a goniometer 307 configured to provide measured rotation to sample 310. Stage 305 may be controlled using a controller (e.g., an integrated stage controller and/or a system controller, not shown).

Probe beam 308 is diffracted by sample 310, generating a specular beam 312 and diffracted beams 313. Beams 312 and 313 are received at a screen 317. The diffraction patterned is a Fourier transformed image of the pattern that contains pattern information.

A camera 318 (such as a charge coupled device or CCD camera, a complementary metal oxide semiconductor or CMOS camera, or photodiode array camera) receives light from screen 317 and generates signals indicative of the intensity of the diffraction pattern at positions on screen 317. The signals indicative of the diffraction pattern may be received by a processor, which may determine one or more sample characteristics based on the signals.

For multiple incident wavelengths, camera 318 may be a wavelength-sensitive camera, such as a color CCD camera. As noted above, different wavelengths are more sensitive to pattern features of particular sizes. As a result, a first wavelength may provide more complete information about some pattern features, while a second, different wavelength may provide more complete information about different pattern features. Thus, using multiple wavelengths may provide a special benefit for samples in which different feature sizes are of interest.

FIG. 4 shows a diffraction pattern 490 that may be obtained using a system such as system 300 of FIG. 3, with blue and green incident light. Blue light has a shorter wavelength, and so the diffraction maxima corresponding to diffracted blue light are closer together than the diffraction maxima corresponding to diffracted green light. In FIG. 4, the diffraction maximum 460 corresponding to specular beam 312 is displaced from the ideal position 461 by a warpage vector 462. Ideal position 461 is the position at which specular beam 312 would be detected in the absence of warpage at the region of the sample being characterized at the particular time. Diffraction pattern 490 further includes a number of intensity maxima, such as spots 465B (corresponding to incident blue light) and 465G (corresponding to incident green light).

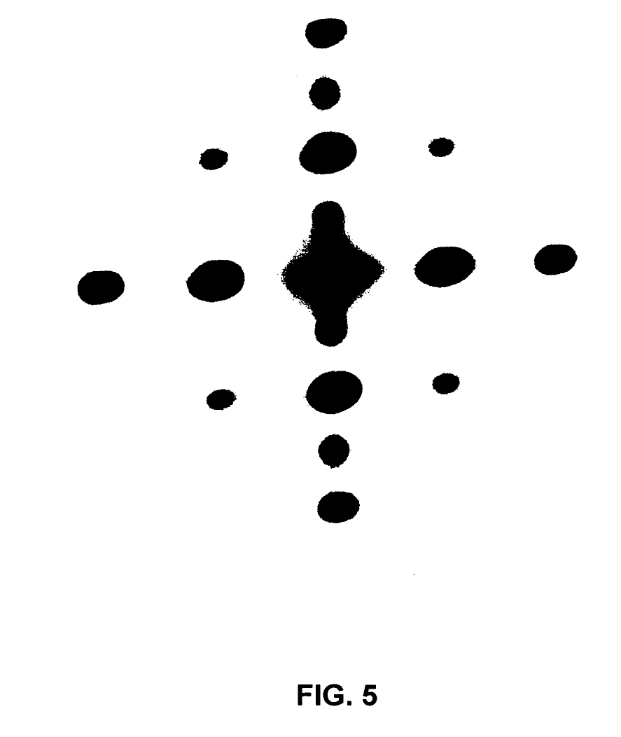

For a “perfect” sample in the region being sampled by the probe beam, the diffraction maxima would form an array of spots with sharp edges, where the positions of the spots may be calculated using the wavelength of light and sample parameters. However, for a flawed sample, the boundaries of the spots may blur, and their positions may deviate from the calculated position. Since the spatial intensity variation of the diffraction pattern is the Fourier transform of the diffracting structure, intensity information may be obtained using detection system 315, and an inverse Fourier transform performed. The result of the inverse Fourier transform may be compared to a result for an ideal sample and/or pattern, to determine sample characteristics. Alternately, the intensity variation for an ideal sample may be determined (e.g., by Fourier transforming the ideal sample and/or pattern) and compared to the obtained intensity data. FIG. 5 shows an exemplary illustration of a diffraction pattern for a patterned wafer illuminated by a laser pointer. The blurring of the diffractions spots indicates that it is an imperfect sample. The contrast between spots and spotless regions tells us the pattern integrity (periodicity and/or regularity).

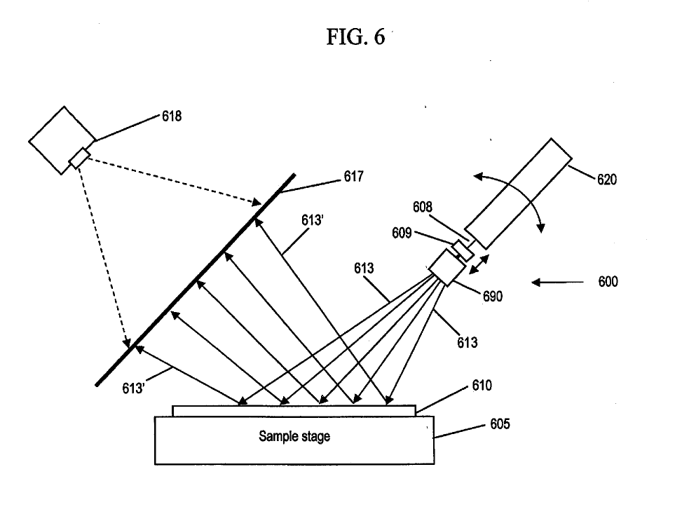

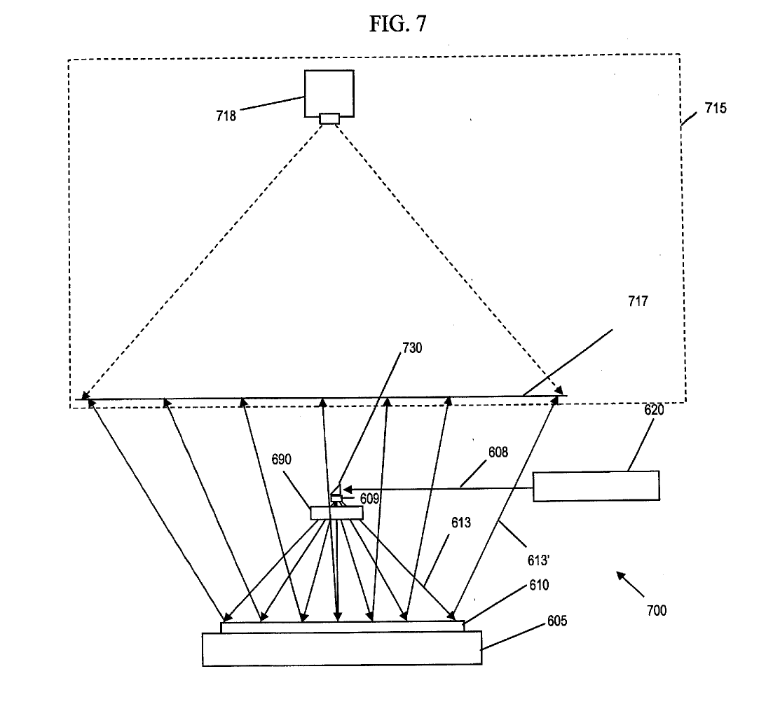

FIG. 6 shows another embodiment of a system 600 configured to characterize a sample 610, such as a patterned or an unpatterned semiconductor wafer. A light beam 608 is generated by a light source 620, which may be coherent or incoherent. Light source 620 may be a single or multi-wavelength laser at UV, VIS, or IR, for example. Light source 620 may also be formed from a plurality of lasers, each generating one or more laser beams. Beam 608 is directed through a pattern generator 609, which may be, for example, a diffraction grating, phase hologram, or mask with a pattern (which may be one- or two-dimensional) to produce a beam pattern 613. Beam forming optics 690 may be included before and/or after pattern generator 609 to scale and/or image the pattern on sample 610. Pattern generator 609 may also be translated toward or away from light source 620 to alter the size of the pattern projected on sample 610.

Beam forming optics 690 may be additionally provided with vibrating or rotatable mirrors, prisms or the like (not shown) to scan and/or position beam pattern 613 to illuminate sample 610. A combination of motions in more than one angular direction may be accomplished using one or more mirrors in beam forming optics to achieve direction of beam pattern 613 to any desired region of sample 610.

Sample 610 may be mounted on a stage 605 so that relative movement between sample 610 and pattern beam 613 may be provided. Stage 605 may be substantially the same as stage 105, and will not be described in detail. Pattern beam 613 may be scanned across sample 610 to obtain data at a plurality of positions to obtain data for a “map” of sample characteristics, where characteristics may include flatness, distortions, warpage, and/or stress information about the wafer surface being illuminated. As noted above, one or more optical elements in beam forming optics 690 may be used to increase or decrease the size of pattern beam 613 at sample 610. To accomplish this, beam forming optics 690 may be optionally disposed in segments both before and after pattern generator 609. Smaller pattern beams 613 may be used to obtain more detailed information about portions of sample 610, while larger pattern beams 613 may be used to characterize an entire wafer more quickly. This provides significant flexibility for different characterization applications.

The example of FIG. 6 shows an embodiment in which pattern beam 613 is incident on sample 610 at an angle relative to the normal to the surface of sample 610. If the surface of sample 610 is not flat in the region sampled by pattern beam 613, the reflected beam 613′ will be received by a detection system, which includes a screen 617 to receive reflected pattern beam 613′. Reflected pattern beam 613′ may be distorted from the original pattern beam 613. The pattern distortion may be referenced to an undistorted pattern to produce a warpage vector map over the surface of sample 610. A CCD camera 618 or other image capturing device then processes the image on screen 617 for determination of wafer characteristics. Camera 618 may be placed on either side of screen 617, which may depend in part on the location of light source 620. Sample 610 (or wafer) and stage 605 may be kept stationary if pattern beam 613 is such that the whole wafer is measured at once. If, however, the wafer or sample is measured in sections, stage 605 or light source 620 may be moved.

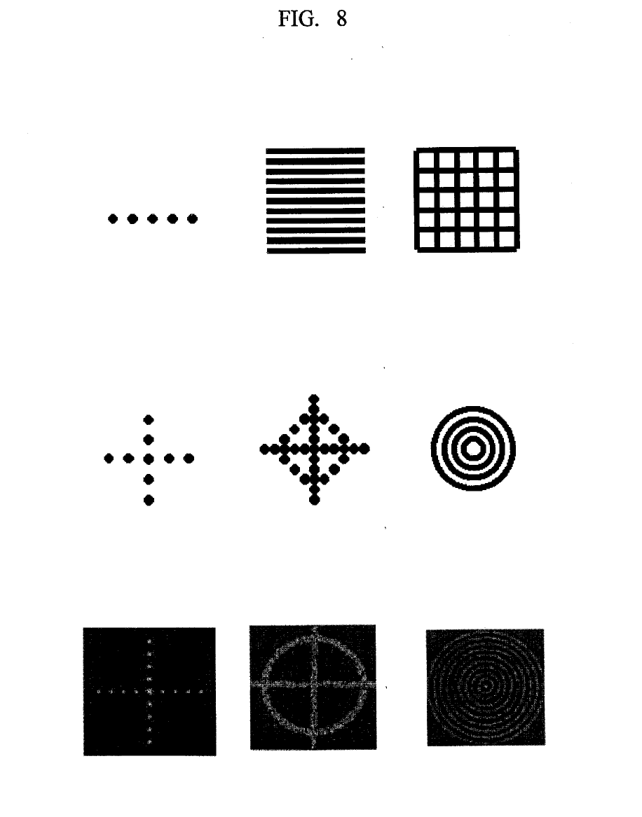

FIG. 7 is a schematic diagram of a sample characterization system 700, which includes detection system 715 comprising camera 718 and screen 717, according to one embodiment. In FIG. 7, beam pattern 613 may also be directed to the surface of sample 610 substantially normal to the surface. For such embodiments, characterization system 700 may have a partially transparent beam splitter (not shown) or a prism 730 to direct beam pattern 613 to a portion (or all) of sample 610. Using the beam splitter or prism 730 in the center of the field of view to turn beam 608 through an angle (for example, 90 degrees) before directing it through pattern generator 609 and, optionally, beam forming optics 690, may also occlude a small portion of the field of view on screen 617. Moving sample 610 and/or detection system 715 may easily recover this portion of the lost field. Sample surface characteristics and/or pattern characteristics may be calculated using techniques that account for the particular angle of incidence used to remove distortions related to field of view, focal depth, and other optical field properties not related to the surface of sample 610. Note that as with the embodiment of FIG. 6, camera 718 may be placed on the other side of screen 717, depending on system parameters.

FIG. 8 illustrates various types of beam patterns that may be used in sample characterization system 600 or 700. These types are not exhaustive, as other beam patterns may also be suitable, such as, but not limited to, a single square, multiple vertical lines, a square dot matrix, a single circle, a dotted square, and a dotted circle.

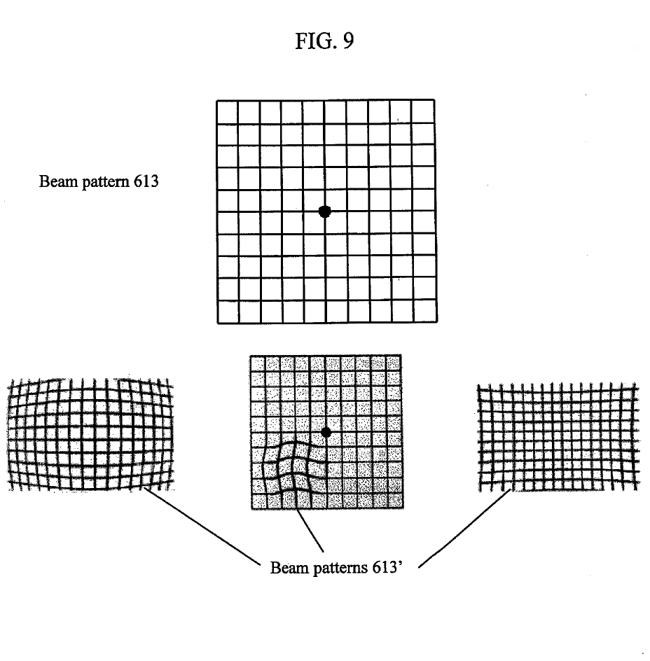

FIG. 9 illustrates various types of distorted beam patterns 613′ that may be detected from a non-flat surface. Assume beam pattern 613 provided by pattern generator 609 is a rectangular grid. Various types of stress distortion of sample 610 may be detected in the beam pattern 613′ received, for example, at screen 617 or 717, such as, for example, bowing (convex or concave) and local “dimples”, or other distortions.

Pattern beam 613′ is not a Fourier transformed image as described for previous embodiments wherein probe beam 308 produces diffracted beams 313′ where the diffraction originates at the surface of sample 310 due to sample features. In the present case, where pattern beam 613′ is detected, there is no requirement for inverse Fourier computation. Relatively straightforward comparison of the directly received image of pattern beam 613 to that of an ideal sample and/or pattern may generate stress vector mapping (both in-plane and out-of plan) of sample 610.

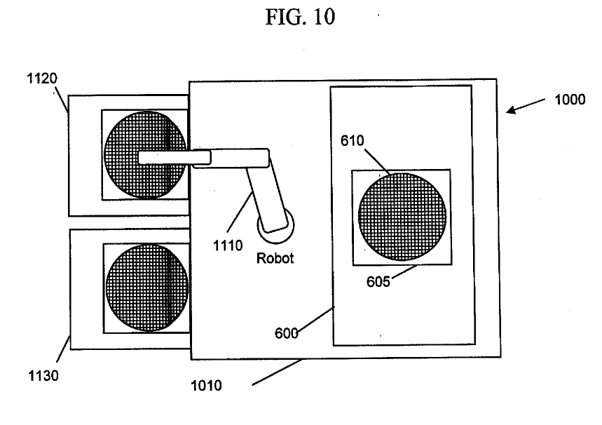

FIG. 10 is a schematic illustration of an exemplary workstation 1000 that includes a sample characterization system 600 and a sample handling system 1010. Sample handling system 1010 further includes a sample handler 1110, such as a robot arm, for example, a sample delivery cassette system 1120 and a sample retrieval cassette system 1130. Sample handler 1110 acquires sample 610 from delivery cassette system 1120 and places sample 610 on sample stage 605. Sample stage 605 may be enabled to align sample 610, or alternatively, an additional sample alignment stage (not shown) may be provided separately in sample handling system 1010. Sample handler 1110 may also provide for transferring sample 610 from the alignment stage to stage 605. After sample characterization, sample 610 is transferred by sample handler 1110 from stage 605 to retrieval cassette system 1130. Sample handling system 1010 components, including sample handler 1110, delivery cassette system 1120, and retrieval cassette system 1130, may further be coupled to processor 140 and controller 130. Alignment of sample 610 may be performed on stage 605, or, alternatively, on a separate sample aligner included in sample handling system 1100. Sample handler 1110 performs sample transport operations, including moving samples 610 from delivery cassette system 1120 to sample characterization system 600, and then to retrieval cassette system 1130. Details of such a sample handling system may be found in commonly-owned U.S. Pat. No. 6,568,899, entitled “Wafer Processing System Including a Robot”, which is incorporated by reference in its entirety.

In implementations, the above described techniques and their variations may be implemented at least partially as computer software instructions. Such instructions may be stored on one or more machine-readable storage media or devices and are executed by, e.g., one or more computer processors, or cause the machine, to perform the described functions and operations.

A number of implementations have been described. Although only a few implementations have been disclosed in detail above, other modifications are possible, and this disclosure is intended to cover all such modifications, and most particularly, any modification which might be predictable to a person having ordinary skill in the art. For example, the incident light may be transmitted to the sample in a number of different ways (e.g., using fewer, more, and/or different optical elements than those illustrated). Furthermore, relative motion between the sample and the probe beam may be provided by moving the sample (as shown), by moving the probe beam, or both. For example, at least part of the optical system may be configured to scan the probe beam across a fixed sample.

Additionally, rather than a single controller, multiple controllers may be used. For example, a stage controller and separate detection system controller may be used. Controllers may be at least partially separate from other system elements, or may be integrated with one or more system elements (e.g., a stage controller may be integrated with a stage). Additionally, multiple processors may be used, and may include signal processors and/or data processors.

Also, only those claims which use the word “means” are intended to be interpreted under 35 USC 112, sixth paragraph. Moreover, no limitations from the specification are intended to be read into any claims, unless those limitations are expressly included in the claims. Accordingly, other embodiments are within the scope of the following claims.

What is claimed is:

1. A sample characterization system comprising:
a sample holder configured to position a sample to be characterized;
a light source configured to generate a beam pattern configured to be directed toward a first region of the sample; and
a detection system configured to receive a reflected beam pattern from the sample, wherein the reflected beam sample is used to determine one or more surface characteristics of the first region of the sample.

2. The system of claim 1, wherein the light source is a coherent light source.

3. The system of claim 1, further including a diffraction grating or phase hologram following the light source to generate the beam pattern.

4. The system of claim 2, wherein the coherent light source comprises a single wavelength source.

5. The system of claim 2, wherein the coherent light source comprises a multiple wavelength source.

6. The system of claim 3, further comprising optical elements to provide operations that include one or more of positioning, scaling and imaging of the beam pattern at the sample surface.

7. The system of claim 1, wherein the light source is an incoherent light source.

8. The system of claim 7, further comprising:
a mask pattern receiving the incoherent light, wherein the mask is positioned to be imaged on the sample; and
optical elements to provide operations that include one or more of positioning, scaling and imaging of the mask pattern at the sample surface.

9. The system of claim 1, wherein the detection system comprises a screen positioned a distance from the sample holder, and further comprises a camera positioned to receive light from the screen and to generate a signal indicative of an intensity of the reflected beam pattern.

10. The system of claim 9, wherein the camera comprises at least one of a charge coupled device (CCD) camera, a complementary metal oxide semiconductor (CMOS) camera, and a photodiode detector array.

11. The system of claim 1, wherein the beam pattern is directed toward the first and a second region of the sample with a one or more vibrating or rotating mirrors, wherein the vibrating or rotating is about one or more angular directions.

12. The system of claim 1, wherein the sample is selected from the group consisting of a patterned substrate and an unpatterned substrate.

13. The system of claim 12, wherein the sample surface characteristics comprise at least one of substrate stress, substrate warpage, and substrate curvature.

14. The system of claim 1, wherein the sample holder is configured to move the sample relative to the beam pattern.

15. The system of claim 1, wherein the light source is configured to move relative to the sample.

16. The system of claim 1, wherein the beam pattern is a pre-defined pattern.

17. The system of claim 1, wherein the first region comprises the entire surface of the sample.

18. The system of claim 1, wherein the first region comprises less than the entire surface of the sample.

19. An article comprising a machine-readable medium embodying information indicative of instructions that when performed by one or more machines result in operations comprising:
receiving information indicative of an intensity of a reflected beam pattern at a first position of a detection system, the reflected beam pattern including light reflected from a first region of a sample by an incident pre-defined beam pattern; and
determining one or more sample surface characteristics of the first region of the sample using data indicative of the intensity of the reflected beam pattern.

20. The article of claim 19, wherein the sample surface characteristics comprise at least one selected from the group consisting of sample stress, sample warpage, and sample curvature.

21. A method of sample characterization comprising:
generating a patterned light beam;
directing the patterned light beam to a first region of a sample;
receiving a reflected light pattern from the first region of the sample;
positioning a detection system to receive the reflected light pattern from the sample;
detecting the reflected light pattern from the first region of the sample;
generating a signal indicative of a first intensity of the reflected light pattern corresponding to the first region of the sample; and
determining one or more sample surface characteristics based on the signal indicative of the first intensity.

22. The method of claim 21, further comprising repeating the receiving, positioning, detecting, generating and determining at a one or more second regions of a sample wherein a portion or all of the entire sample area is characterized.

23. The method of claim 21, wherein the first region comprises the entire sample area.

24. The method of claim 21, wherein generating the signal comprises receiving the reflected light on a screen included in the detection system and generating the signal using a camera configured to image the screen.

25. The method of claim 24, wherein the camera comprises at least one of a CCD camera, a CMOS camera, and/or a photodiode detector array.

26. The method of claim 25, wherein the camera comprises a color CCD camera, a color CMOS camera and/or a filtered photodiode detector array.

27. The method of claim 25, wherein the determining comprises comparing the reflected light pattern with an undistorted pattern.

28. A sample characterization system comprising:
means for generating a light pattern;
means for directing the light pattern;
means for positioning a sample to be characterized wherein the light pattern illuminates at least a region of the sample;
means for receiving a reflected light pattern from the sample to determine one or more sample surface characteristics of the region of the sample surface.
